(19) United States
(12) Patent Application Publication
(10) Pub. No.: US 2006/0031622 A1
(43) Pub. Date: Feb. 9, 2006

(54) Software transparent expansion of the number of fabrics coupling multiple processsing nodes of a computer system

(76) Inventor: Robert L. Jardine, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/048,525

(22) Filed: Feb. 1, 2005

Related U.S. Application Data
(60) Provisional application No. 60/577,749, filed on Jun. 7, 2004.

(51) Int. Cl. G06F 13/36

(52) U.S. Cl. 710/310

(57) ABSTRACT

The number of fabrics coupling a plurality of processing nodes of a computer system is expanded from a first fabric and second fabric known to the I/O services layer residing at each processing nodes to a first and second plurality of fabrics. A current mapping is maintained at each of the processing nodes between the first fabric and one of the first plurality of fabrics and between the second fabric and one of the second plurality of fabrics for each of the processing nodes. Messages are transmitted by one or of the plurality of processing nodes acting as a source node to one or more of the other processing nodes as a destination node over one of the first and second plurality of fabrics in accordance with the current mapping for the destination node residing at the source node and based on which of the first and second fabrics are specified in the requests of the I/O services layers.

This application claims the benefit of U.S. Provisional Application No. 60/577,749, filed Jun. 7, 2004.

### BACKGROUND

For nearly 30 years, large computer systems have been designed and built to address on-line (and thus real-time) transaction processing for such applications as banking, database management and the like. These computer systems, often referred to as servers, are designed to run non-stop while providing a high degree of availability and reliability (long meantime to failure). To accomplish this, these servers are designed with a high degree of hardware and software modularity and redundancy. For example, the server's processing resources are distributed over a large number of processing nodes operating in parallel. Processing nodes generally include both processor nodes (i.e. CPU processor modules) as well as input/output (I/O) controller nodes driving I/O devices such as disk drives, Ethernet adapter cards and the like. A failure of one processing node can be overcome through a redistribution of the workload over the remaining processing nodes. The processing power of today's non-stop servers can be scaled upward through the clustering of literally thousands of CPU modules and input/output (I/O) controller modules running in parallel.

Until recently, the processor nodes (i.e. CPU modules) traditionally have been coupled together through an interprocessor communications (IPC) bus over which messages are transmitted between the processor nodes. These messages serve, among other functions, to coordinate the activities of the processor nodes into a collective whole. Just as in the case of software and hardware components, fault tolerance is achieved through duplication of the IPC bus as well. This dual IPC bus has been referred to generically as the “X” and “Y” bus, and specifically to “Dynabus” in products sold by Tandem Computers, Inc. Although both paths are used when they are operational, should one of the buses fail, the server can tolerate this fault and continue to run with only one path until the problem is located and repaired.

Early server designs used the dual IPC bus only for interprocessor communications (i.e. between processor nodes), but not for communicating with the (I/O) controller modules of the server. Separate and redundant I/O buses were also used to couple CPU modules to I/O controllers. Typically, redundancy was achieved through dual ported I/O controller nodes coupled to two distinct I/O buses, each connected to a different one of the processor nodes. More recent designs have combined interprocessor communications (i.e. message transactions) and I/O (data transfer) transactions over a system area network (SAN) having dual fabrics, an “X” fabric and a “Y” fabric. By combining the transaction types together, they share hardware and software, and the overall design is more robust because there are now fewer paths that can fail. For additional background regarding the use of a SAN to handle both IPC and I/O data transactions, see U.S. Pat. No. 5,751,932 entitled “Fail-Fast, Fail-Functional, Fault-Tolerant Multiprocessor System,” which is incorporated herein in its entirety by this reference.

As the demand for processing power from servers continues to increase, so does the number of processing nodes coupled to these dual buses or fabrics. In the case of the SAN architecture, the combining of both processor nodes and controller nodes significantly increases the demand for bandwidth on the fabrics. Bandwidth is further increased by ever-increasing processing speed of the CPU and I/O modules and the desire to keep message latencies low. Further exacerbating the problem is the fact that in a dual bus/fabric architecture, both buses or fabrics cannot be relied upon to double the bandwidth to support transactions between the processing nodes coupled thereto. This is because the server must be designed to run unaffected by a fault in one of the buses or fabrics, which means that the processes running on the server must be sized to run with only one of the buses or fabrics operational. Put another way, the second bus or fabric must be assumed to be an “idle standby” for purposes of performance.

Thus, it has become highly desirable to expand the number of buses or fabrics beyond the two that have been traditionally used in such systems. The impediment to this is that an enormous amount of time and resources have been invested over the years in the dual bus or dual fabric architecture. Software written to coordinate the request for and initiation of communication transactions between processing nodes, whether they be CPU modules (messaging transactions) or I/O controllers (data transactions) contemplates only two buses or fabrics. This is especially true for IPC messages, for which dual buses (and now fabrics) have been employed since the very first non-stop servers were designed. As a result, to expand the number of buses or fabrics beyond the traditional two would require an enormous undertaking in software development.

### BRIEF DESCRIPTION OF THE DRAWINGS

For a detailed description of embodiments of the invention, reference will now be made to the accompanying drawings in which:

FIG. 1 is a block diagram that illustrates a computer system employing a traditional dual IPC bus for message transfer between processor nodes of the computer system;

FIG. 2 is a block diagram of a known computer system that combines message and data transactions over dual fabrics of a SAN;

FIG. 3 is a block diagram of an embodiment of the processor nodes of the computer system of FIG. 2;

FIG. 4 is a block diagram of an embodiment of the SAN routers of the computer system of FIG. 2;

FIG. 5A is a block diagram illustrating the hierarchical relationship of software services layers running on each of the processor nodes of the computer system of FIG. 2;

FIG. 5B is a block diagram illustrating the hierarchical relationship of the various software services in handling a transaction request between client processes running on two of the processing nodes of the computer system of FIG. 2;

FIG. 6 is a block diagram illustrating an embodiment of the computer system of FIG. 2 for which the number of fabrics has been expanded to n fabrics Xᵢ and m fabrics Yⱼ in accordance with the invention.

FIG. 7 is a block diagram representation of an embodiment of a virtual to physical fabric mapping table in accordance with the invention.

FIG. 8 is a block diagram illustrating an embodiment of the computer system of FIG. 1 for which the number of buses has been expanded to n buses Xᵢ and m buses Yⱼ in accordance with the invention.

FIG. 9 is a procedural flow diagram illustrating an embodiment of the mapping and translation process of the invention.

### NOTATION AND NOMENCLATURE

Certain terms are used throughout the following description and in the claims to refer to particular features, apparatus, procedures, processes and actions resulting therefrom. In addition, those skilled in the art may refer to an apparatus, procedure, process, result or a feature thereof by different names. For example, the term processing node is used to generally denote both a CPU module and an I/O controller coupled to an interprocessor communication (IPC) fabric or bus, while the terms processor node and controller node are intended to denote each type respectively. This document does not intend to distinguish between components, procedures or results that differ in name but not function. For example, the terms IPC bus and IPC fabric may be used interchangeably at times herein. An IPC fabric typically denotes buses coupling processing nodes (including both central processing unit (CPU) modules and input/output (I/O) controllers) through a series of switches or routers, to form a system area network (SAN). An IPC bus typically refers to the more traditional dual bus architecture coupling only processor nodes (i.e. CPU modules). While effort will be made to differentiate between fabrics and buses, those of skill in the art will recognize that the distinction between the two is not critical to the invention disclosed herein. In the following discussion and in the claims, the terms “including” and “comprising” are used in an open-ended fashion, and thus should be interpreted to mean “including, but not limited to . . . .”

### DETAILED DESCRIPTION

The following discussion is directed to various embodiments of the invention. Although one or more of these embodiments may be preferred, the embodiments disclosed should not be interpreted as, or otherwise be used for limiting the scope of the disclosure, including the claims, unless otherwise expressly specified herein. In addition, one skilled in the art will understand that the following description has broad application, and the discussion of any particular embodiment is meant only to be exemplary of that embodiment, and not intended to intimate that the scope of the disclosure, including the claims, is limited to that embodiment. For example, while the various embodiments may employ one type of network architecture and/or topology, those of skill in the art will recognize that the invention(s) disclosed herein can be readily applied to all other compatible network architectures and topologies.

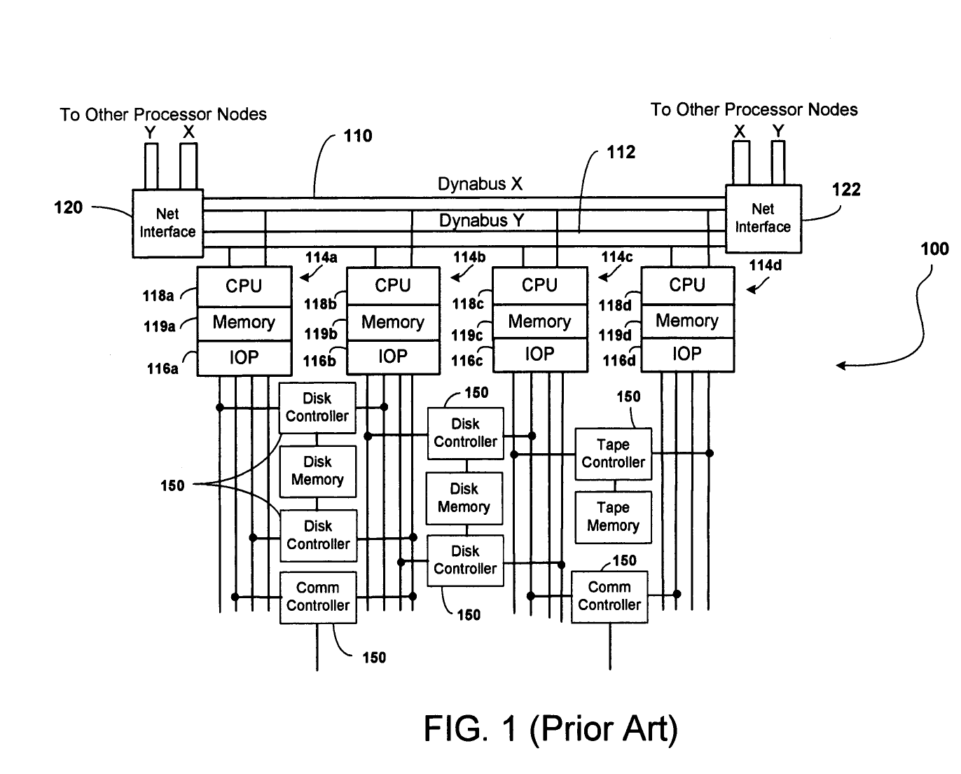

FIG. 1 is a block diagram of a computer system 100 that illustrates a traditional server architecture that includes a dual interprocessor communication (IPC) X Bus 110 and Y Bus 112 by which processor nodes 114a-d are communicatively coupled. Both buses are bidirectional for sending and receiving data. The computer system 100 can be coupled to other such systems through the IPC buses 110, 112 and network (Net) Interfaces 120, 122 to form an even larger and more powerful computer system. The central processing unit (CPU) module comprising each of the processor nodes 114a-d includes at least one CPU 118a-d, memory 119a-d and an input/output (I/O) process (IOP) 116a-d that facilitates communication between the processor node and I/O controllers 150 coupled to the processor nodes as shown.

A messaging system software library running on each of the processor nodes 114a-d initiates message transactions over the dual bus 110, 112 between a source and destination processor node. Each processor node 114a-d is assigned a node (identifier) ID and the messaging system packages messages in the form of packets each containing a node ID corresponding to both the source and destination processing nodes sending and receiving the transaction respectively. A message transaction is initiated and transmitted between the processor nodes 114a-d over one of the dual buses 110 and 112; transactions are never split between the two buses because message packets are expected to be delivered in-order and this can not be guaranteed given variables such as the amount of congestion on each bus at any given time. Initially, an assignment is made for each of the processor nodes to one of the two buses. The messaging system can switch the assignment of a particular processor node from one of the dual buses 110, 112 to the other when the messaging system determines that it is safe to do so (e.g. when no unacknowledged messages have been initiated to a particular destination, or when a “retry” commences after an error requires that an entire message be re-transmitted). Assignments of node ID's and IPC buses are maintained by the messaging system and are updated whenever a reassignment occurs.

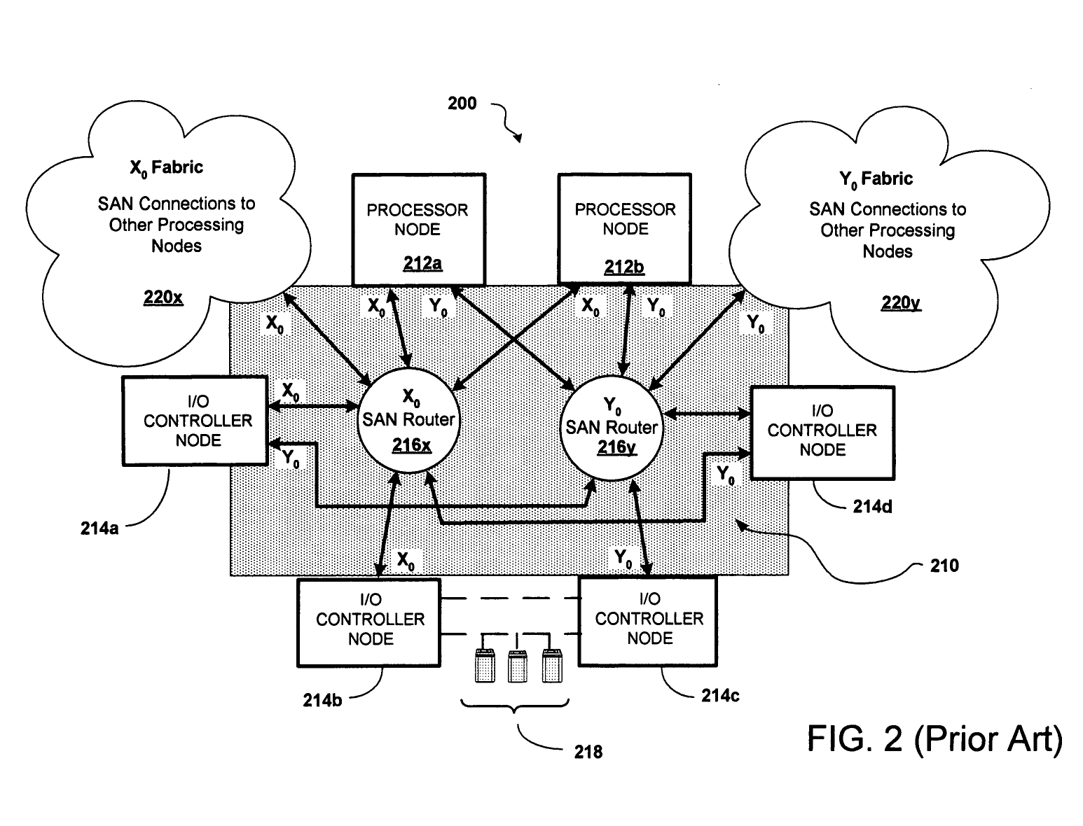

FIG. 2 illustrates an embodiment of a more recent evolution in non-stop server architectures. In this architecture, all processing nodes 212a, 212b, 214a-d (e.g. both processor nodes and I/O controller nodes) of computer system 200 can be coupled to one another through system area network (SAN) 210. The SAN 210 serves to merge the separate IPC and I/O buses of FIG. 1 into two switched fabrics X₀ and Y₀. In the example of FIG. 2 each fabric X₀ and Y₀ couples all of the processing nodes 212a and 212b and all but one of the I/O controller nodes through a SAN router 216x, 216y respectively. Controllers 214b and 214c are illustrated as being coupled to one fabric each because it may be desirable to limit access to a controller node to only one of the fabrics, although the I/O devices 218 to which controller nodes 214a and 214b are coupled are essentially shared between the two fabrics. Expansion to additional processing nodes (perhaps of another computer system similar or identical to system 200) is achieved through router connections to SAN network clouds 220x and 220y. These expansion connections are analogous to those achieved by Net Interfaces 120, 122 of FIG. 1.

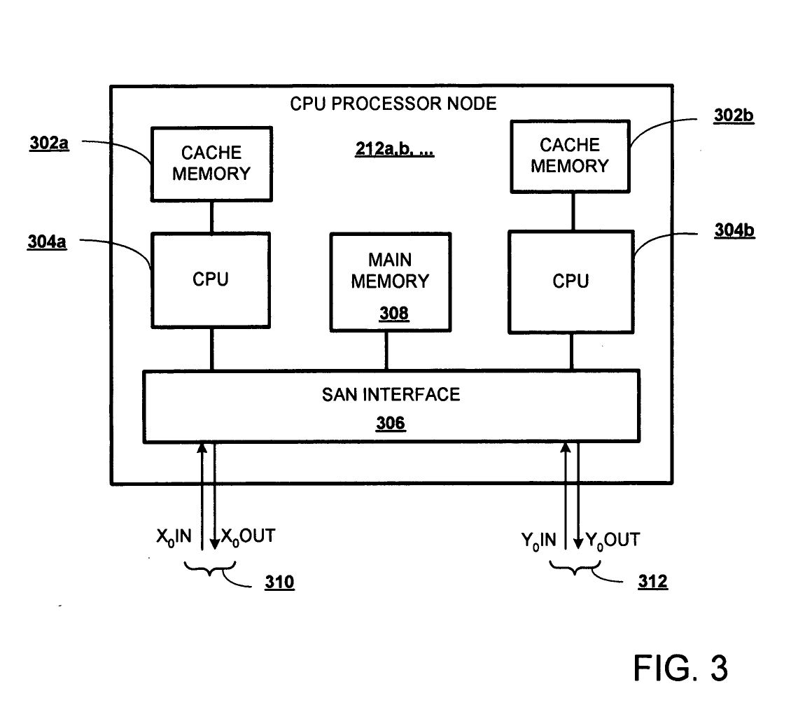

FIG. 3 is a simple block diagram of one possible embodiment of the processor nodes 212a-b of FIG. 2. Each of dual CPUs 304a-b has its own cache memory 302a and 302b respectively, and they share a common main memory 308 between them. The two CPUs 302a and 302b perform the same processing functions in lock-step with one another to provide a fast failure recovery in case one of the CPUs 304a-b fails. Each of the processing paths is coupled to a common SAN interface 306, which provides a physical interface and connection point to the SAN 210 for the CPUs 304a-b as well as between the CPUs and the common main memory 308. The SAN Interface 306 compares every SAN and memory operation performed by the CPUs 304a-b to ensure that they are always identical. It is through the SAN Interface 306 that IPC message and data transactions are transmitted and received to and from other processing nodes coupled to the SAN 210. The SAN Interface 306 provides two bidirectional output ports, one for each of the two fabrics X₀ 310 and Y₀ 312 respectively. Those of skill in the art will appreciate that additional details concerning the processor and controller nodes is beyond the necessary scope of this disclosure.

It should be noted that the processor nodes 114a-d of FIG. 1 are similar in composition to those of FIG. 3. However, they would have dual port interfaces to the IPC (for the X and Y bus) as well as separate multiple I/O interfaces to I/O controller devices as shown in FIG. 1 rather than the single two-port SAN interface 308 of FIG. 3. Those of skill in the art will recognize the advantages of combining both types of interfaces (i.e. interprocessor and I/O) into a single connection to include the ability to use common hardware and software for all types of transactions (i.e. processor node to processor node, processor node to controller node, and controller node to controller node).

Referring to the system 200 of FIG. 2, upon start-up each processing node attached to the SAN 210 is identified by a unique node ID that may be, for example, 20 bits in length. This ID is considered to be the “SAN address” of the node and is used to route I/O transfers between nodes across the SAN 210. SAN IDs are assigned by a service processor (SP) (not shown) during the system startup. During start up, a number of system tables containing information about the system configuration are created by the SP and loaded to a processor node in the system. The SP determines the logical topology of the SAN based on the configuration of the hardware components (that is, types of hardware components and location of hardware components in relation to other hardware components). The SP builds a SAN Node Table (SNT) during configuration, prior to system boot. The information in the SNT and other system tables describes the configuration (that is, the topology) of all SAN processing nodes in the system 200. The node ID for each processor node is loaded into hardware registers of the appropriate SAN interface 306. Each SAN router 216x, 216y is loaded with router tables to implement a routing strategy.

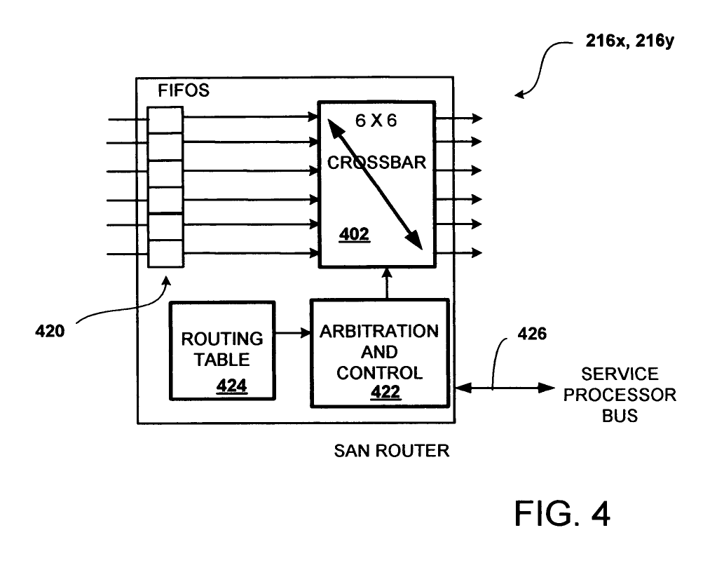

A possible embodiment of Routers 216x and 216y is illustrated in FIG. 4. As illustrated, the router is a 6-port crossbar switch 402 that can simultaneously connect any input with any output. Routers 216x and 216y have first-in-first-out (FIFO) buffers for input 420, logic for routing arbitration and link-level flow control 422, and a routing table 424. Service Processor bus 426 is shown by which the routing tables are loaded at start-up. Those of skill in the art will appreciate that additional details of the routers 216x and 216y, such as flow control and routing strategies are beyond the necessary scope of this disclosure.

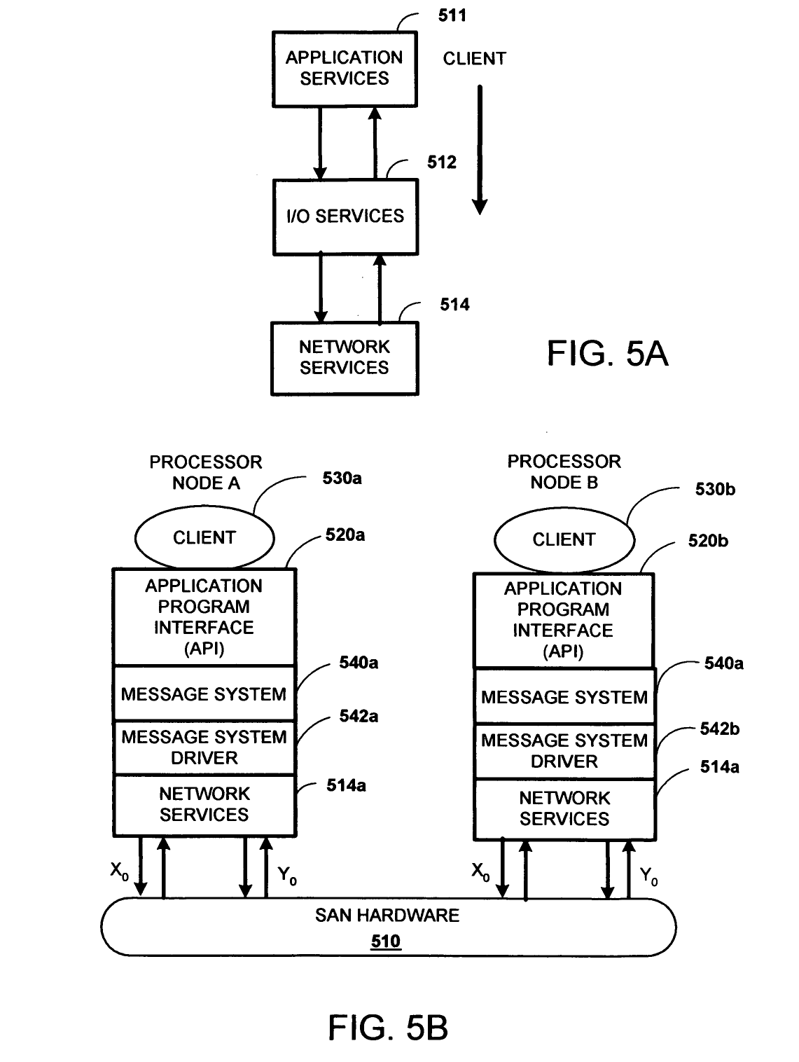

FIG. 5A illustrates an embodiment of some of the software processes that are resident in and executed by each of the processing nodes 212a, 212b, 214a-d (as well as those nodes of fabrics 220x and 220y) of system 200 of FIG. 2. As is evident from the illustration, a hierarchical relationship is created between the layers so that each layer is transparent to the one above it and below it. This permits each layer to be changed without affecting the others. Application services layer 511 typically runs at the top level and includes client processes that initiate requests for I/O services 512. I/O services 512 can include message system services (e.g. interprocessor communications) and storage interface services (e.g. data transactions including controller nodes that are initiated by processor nodes). The network services layer 514 initiates transactions requested by the I/O services layer. Network services layer 514 handles the process of physically transmitting the packets that make up the requested transactions over the SAN 210 to the appropriate destination nodes 212a, 212b, 214a-d and those of fabrics 220x and 220y.

FIG. 5B further illustrates the hierarchical nature of the software processes, instantiations of which reside in each of the processor nodes. In response to a client process 530a (executing in processor node A) requesting an interprocessor message transaction, the message system 540a requests that the network services layer 514a initiate the requested message transaction over the SAN hardware 510. The request from the messaging system 540a will include handles or node IDs for the source and destination processor nodes (in this case processor nodes A and B respectively) and the fabric over which to transmit the message (i.e. either X₀ or Y₀). The network services layer deals with the details of actually initiating the transaction out over the SAN path directed by the message system layer 540a. Those of skill in the art will appreciate that typically, clients are processes, but they can be other operating system related entities as well.

To avoid making major changes to the message system code used in architectures such as the one in FIG. 1, and to isolate SAN-related processing into a separate functional layer, message system services is actually subdivided into two layers: Message-system procedures which are part of the message system layer 540a,b and message-system driver procedures which are part of the message system driver layer 542a, b. Message-system procedures are a library of procedures and form part of the operating system running on the computer system. These are the basically the same procedures that are present in the message systems of previous implementations of dual bus architectures such as illustrated in FIG. 1. Message system driver procedures are a library of procedures and are also part of the operating system. These procedures act as a layer between the message-system procedures and the network services. This layer contains the SAN-specific knowledge required to send and receive messages using network services layer 514a, b.

As previously mentioned, message latency and the desire for even more robustness has made it highly desirable to expand the number of fabrics or buses beyond the traditional dual bus architecture. However, the messaging system software has become highly installed and would be extremely difficult and time consuming to rewrite to handle additional fabrics. The dual fabric/bus architecture has become deeply embedded in the existing code.

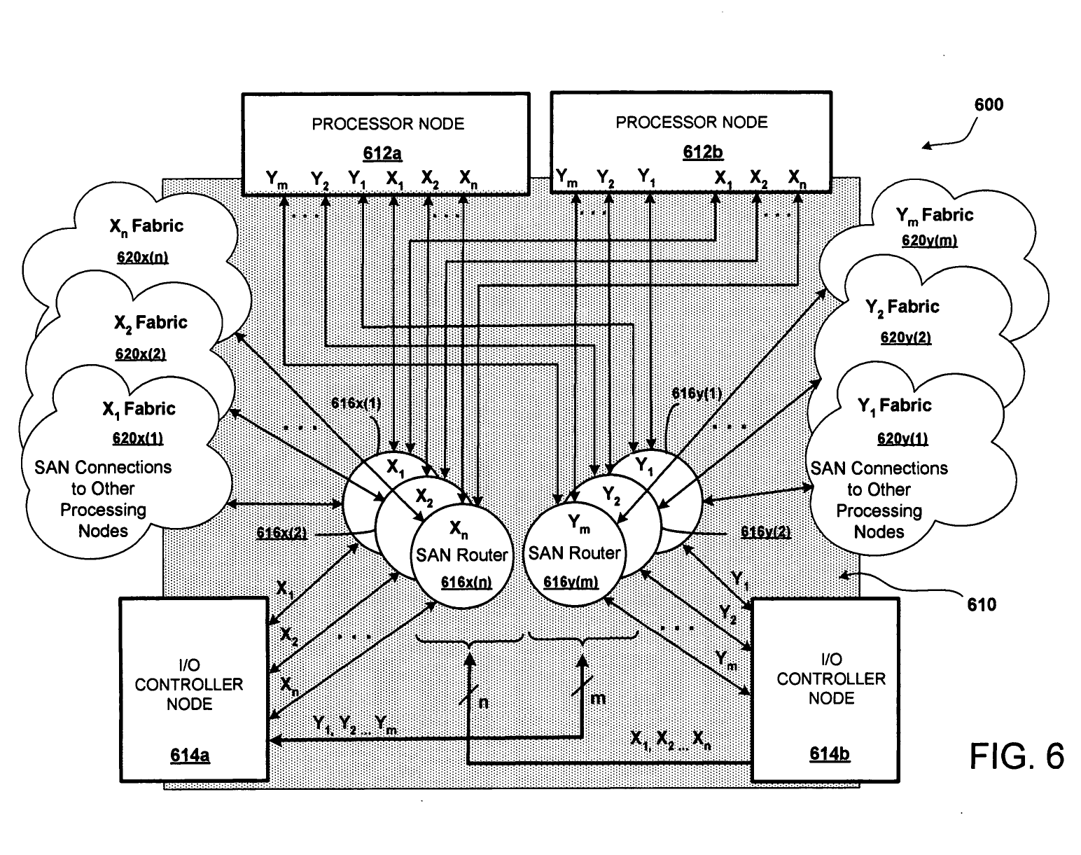

FIG. 6 illustrates an embodiment of a computer system 600 where the number of fabrics of SAN 610 has been expanded to n fabrics Xᵢ and m fabrics Yⱼ, where i=1 to n and j=1 to m; and where n and m are any integer. A minimum of n routers 616x(1-n) for the fabrics Xᵢ and m routers 616x(1-m) for the fabrics Yⱼ are used to interconnect the processing nodes for each of the fabrics. These routers can be implemented substantially as those illustrated in FIG. 4. The SAN interface (not shown) for each processor node must now have n (for the Xᵢ fabrics)+m (for the Yⱼ fabrics) total bidirectional ports. Moreover, there are now n+m additional connectors available to other processing nodes that can be added to the fabric through the router links, as illustrated by the network clouds X₁, X₂, . . . Xₙ and Y₁, Y₂, . . . Yₘ. The controller nodes 614a and 614b are coupled to all of the fabrics, but the m links to the Yⱼ fabrics for controller node 614a are consolidated to one line for simplicity, and likewise for the n links to fabrics Xᵢ for controller node 614b.

In an embodiment of the computer system 600, a technique is implemented to expand the number of fabrics transparently to the messaging system. To accomplish this, a technique is employed that is similar to that of translating virtual to physical memory employed in many computer systems. The network services 514 of FIG. 5A layer (that resides in each of the processing nodes 612a, 612b, 614a, 614b as well as those nodes of fabrics 620x(1-n) and 620y(1-m)) has been modified to establish a mapping between the original two fabrics X₀ and Y₀ (for which the I/O services layer 512 has been originally programmed to recognize) each to one of the expanded fabrics Xᵢ and Yⱼ respectively. This mapping may be performed independently for each of the processing nodes (or just the processor nodes) coupled to the SAN 610 such that X₀ is mapped to one of the fabrics Xᵢ and Y₀ is mapped to one of the fabrics Yⱼ for each individual node

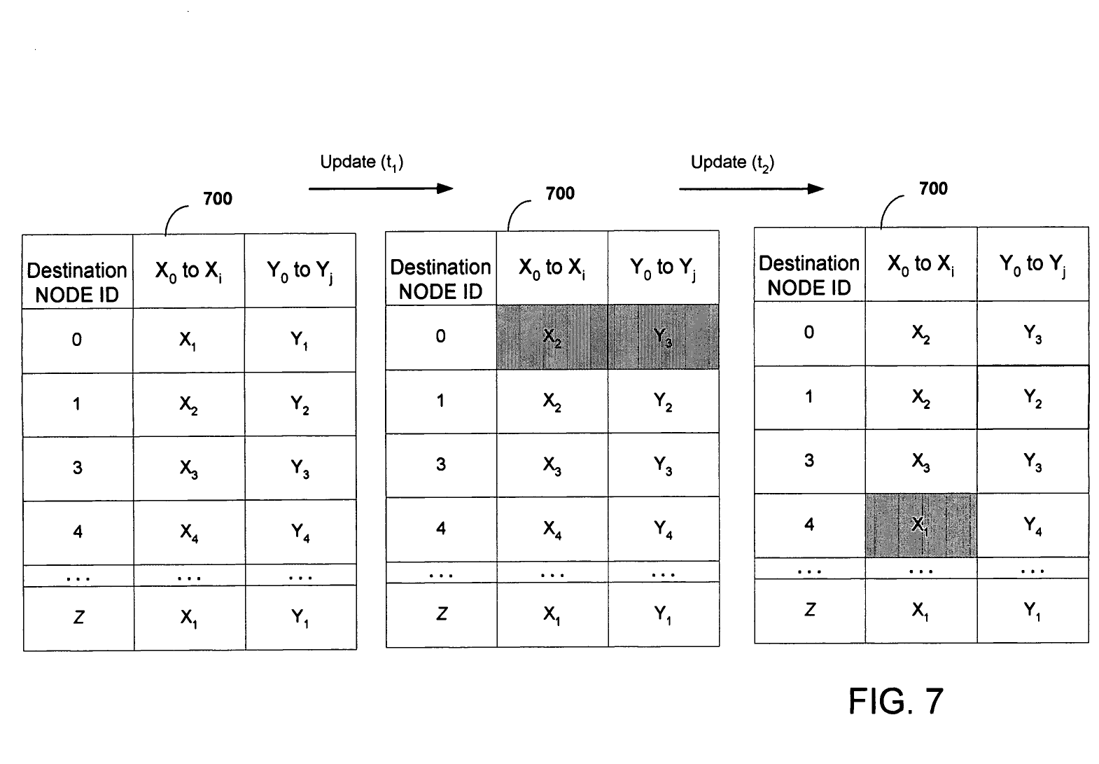

In an embodiment illustrated in FIG. 7, the network services layer 514 establishes an initial mapping at system start up in a table such as that illustrated in table 700 for each processing nodes 1 through Z. In the example of FIG. 7, n=m=4. In an embodiment, the table for a source node S may have an entry for each possible destination node. The entry would contain a node ID and a current mapping assignment to Xᵢ and Yⱼ. When for example, the message system 540a, FIG. 5b requests that a message transaction be initiated between a source node and a destination node over (what the message system is unaware has now become) the virtual X₀ fabric, the network services 514 layer simply initiates the transaction on the physical fabric Xᵢ to which the node ID for the destination node is currently assigned in accordance with the map of the source node. The same would be true for the case of the message system specifying the transaction for the Y₀ virtual fabric. The network services layer would actually initiate the transaction over the physical Yⱼ fabric to which the destination node is currently assigned in accordance with the map of the source node.

In the example of FIG. 7, when the message system of the source node maintaining the table 700 requests a message be sent to the destination node having node ID #3 over the “virtual” Y₀ fabric, the network services layer of the source node will actually transmit the packets constituting the message to the destination node assigned ID #3 over the actual fabric Y₃. If the transaction had been requested over virtual fabric X₀, the network services layer would have instead initiated the transaction over the X₃ fabric.

The foregoing translation process from one of the original two fabrics to one of the number of actual fabrics is completely transparent to the instantiation of the message system for each processor node. The message system layer therefore does not have to be re-engineered to accomplish the expansion in the number of fabrics. Those of skill in the art will recognize that the same transparent mapping process can also be accomplished for the controller nodes performing data transfers, as this portion of the I/O services layer (512, FIG. 5A) is also hierarchically separate from the network services layer 514. A table can also be maintained at each controller node as described above and the entries for the tables maintained by all processing nodes would include both processor and controller nodes as destination node entries. Moreover, the same type of single-parameter API can be inserted into the code for requesting data transactions to call the network services layer of a source node to notify it that it is safe to change mapping for a destination controller node.

In an embodiment, the mapping can be initially set up (at start-up) to evenly distribute the total number of processor nodes to each of the expanded fabrics, which at least provides the opportunity to more evenly distribute messages between the nodes. For example, if n=m=2, then this could be accomplished by initially assigning all processor nodes having odd-numbered node IDs to X₁ and Y₁ and all even numbered IDs to X₂ and Y₂. As illustrated in FIG. 7, n=m=4, and so initially every four nodes can be initially assigned X₁ and Y₁ through X₄ and Y₄. Those of skill in the art will appreciate that the manner in which the mapping is initially established is not critical to the invention.

It may be advantageous to alter the mapping periodically to help balance the traffic between nodes (perhaps in accordance with a load balancing algorithm). This change in the mapping for any given node must be performed when it is safe to do so. That is, the current mapping assignment cannot be changed while a message is being transmitted to that destination node because there is a risk that packets will be received out-of-order. There are a number of possible indicators of safe opportunities to alter the mapping (e.g. when a “retry” transaction is requested requiring a retransmission of a message).

The easiest way to detect safe opportunities for changing the mapping is to let the message system notify network services of such opportunities. The message system already has code paths designed to detect safe opportunities to change its own assignment of destination node IDs between the two original fabrics X₀ and Y₀. Thus, the mere fact that the message system alters its own assignment remaps a destination node to a physical fabric other than its current assignment (e.g. from some Xᵢ to some Yⱼ) in accordance with the current mapping assignments without even altering the entries. However, it is also advantageous to change the current assignments within the X fabrics as well as within the Y fabrics, so that the mapping also rotates through all of the possibilities even when the message system has not changed the assignment. In an embodiment, an application program interface (API) placed in the safe opportunity detecting code path of the message system layer can be used to call the network services layer and to thereby notify network services of the node ID of a destination node for which it is safe to alter the mapping. At this time, the network services layer can update the table entry for that source processing node with new assignments Xᵢ and/or Yⱼ.

FIG. 7 further illustrates this process for one of the processing nodes acting as a source node S with an updated mapping at time t=t₁ that is stored in the table 700 for the destination node having an ID=0. The new current mapping becomes X₀ to X₂ and Y₀ to Y₃. At time t=t₂ a new current mapping for the destination node #4 becomes X₀ to X₁ and Y₀ to Y₄. It should be clear to those of skill in the art the mapping for each of the original (virtual) fabrics is independent of one another, and thus during an update one may sometimes be updated while the other remains the same. The table locations that were updated at t₁ and t₂ are indicated by the shading in FIG. 7

Those of skill in the art will recognize that the mapping for i=j=2 for a particular processor node can completely cycle in one of the following ways: (X₁ to Y₁ to X₂ to Y₂ to X₁ . . . ) or (X₁ to Y₂ to X₂ to Y₁ to X₁ . . . ). It should also be clear to those of skill in the art that because each processing node maintains its own mapping locally, the mapping between each processing node as a source node and the other nodes as destination nodes can vary from processing node to processing node. Put another way, the mapping established by Node #1 as a source node for communicating with Node #3 as a destination node can be different from the mapping established by Node #2 as a source node communicating with Node #3 as a destination node.

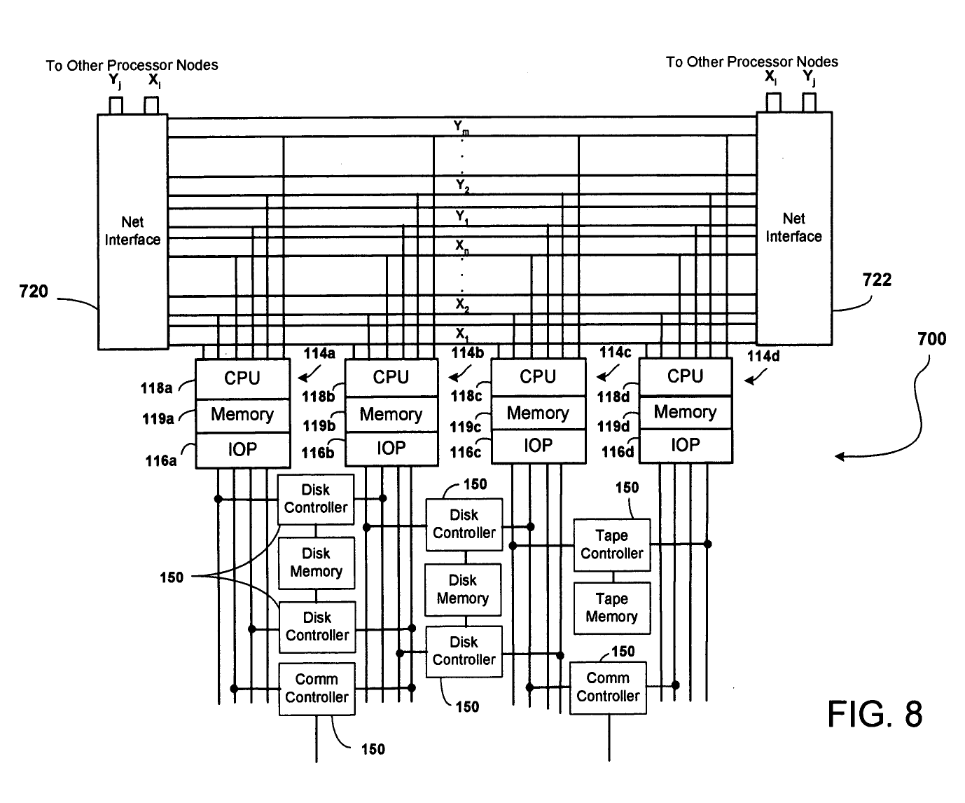

Those of skill in the art will recognize that this technique can be applied to the dual bus architecture of FIG. 1 by keeping the message system procedures isolated from the software services used to initiate the transactions out on the expanded number of IPC buses in the same manner as just described for the SAN context. FIG. 8 illustrates an embodiment of the invention as applied to the architecture of FIG. 1. As can be seen, the number of IPC buses is expanded from the original two IPC buses X 110 and Y 112 to buses X₁ through Xₙ and Yⱼ through Yₘ. Net interfaces 720, 722 are commensurately larger than net interfaces 120, 122 of FIG. 1 to accommodate the expanded number of buses.

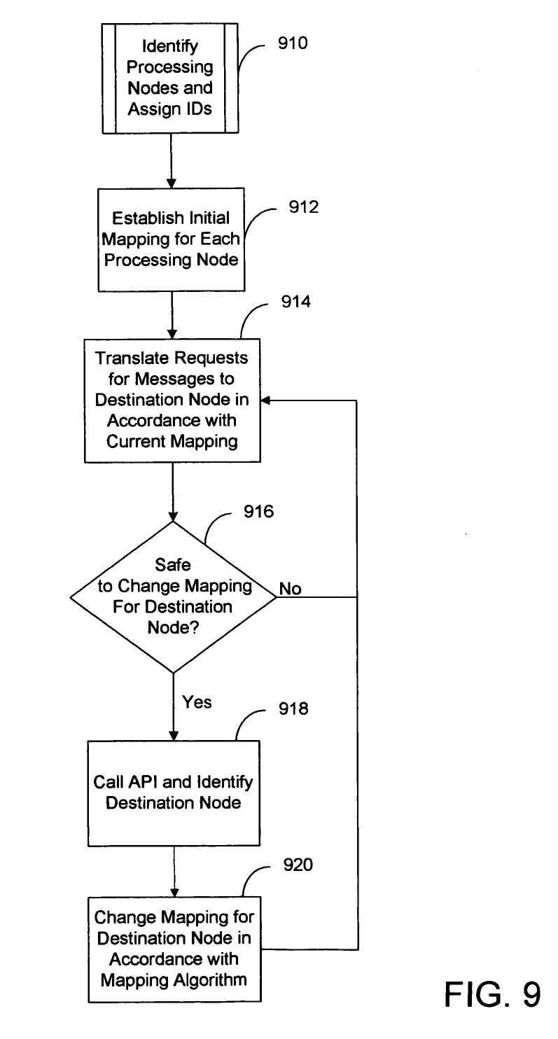

FIG. 9 illustrates a procedural flow of an embodiment of the invention. It should be pointed out that this is not a flow-chart of a particular program, but rather identifies functions of the invention that can span more than one software program layer as described previously. At block 910, the number of processing nodes for the system are identified and assigned Node IDs by a system processor and that information can then be provided to each of the processing nodes. Processing proceeds at block 912, where an initial mapping to destination nodes is established for each processing node of the system that is to communicate as a source to destination nodes over the expanded number of fabrics or buses. This process involves loading the mapping table with the information generated at 910 as well as mapping information that can be based on some algorithm designed to provide an initial distribution of messages over the fabrics. Processing continues at 914, where the network services layer for each processing node acting as a source node initiates transactions at the request of the node's I/O services layer over one of the expanded fabrics or buses in accordance with the current mapping maintained by the source node. It is as part of this process that the I/O services layer (e.g. the message system) can specify in its request whether the message packets are sent over an Xᵢ or Yⱼ fabric or bus by specifying which of the two original or virtual fabrics/buses it wants to use. At 916, if the I/O services layer of the source node determines that it is safe to change the mapping for a particular destination node, it calls an API at 918 to notify the source node's network services layer for which destination node it is safe to alter the mapping. If the API is called for a particular destination node, at 920 the mapping for the particular destination node may be altered. Processing returns to 914 where transaction requests by the I/O services of the source node are initiated over the bus or fabric determined by the new current mapping.

Pre-existing software for requesting interprocessor messaging and data I/O transactions for highly distributed and fault tolerant computer systems that has over the years become deeply invested in the traditional dual fabric/bus architecture can be fooled into thinking it is still operating within that two fabric/bus environment, even though the actual number of fabrics has been expanded to any advantageous number of additional fabrics/buses. Because the messaging and I/O services software can be isolated from software services responsible for physically initiating those transactions over the buses/fabrics, those lower level services can perform a virtual to physical mapping of the two fabrics/buses to the actual number of buses used without knowledge or detriment to the higher level messaging and I/O services. In this way, the advantages of expanding the number of buses/fabrics such as improved fault tolerance and higher bandwidth (which lowers message and I/O latency), can be achieved without resorting to a time consuming and expensive redevelopment of the existing code.

What is claimed is:

1. A method of expanding the number of fabrics coupling a plurality of processing nodes of a computer system from a first and second virtual fabric to a first and second plurality of fabrics respectively, said method comprising:
maintaining a current mapping between the first virtual fabric and one of the first plurality of fabrics and between the second virtual fabric and one of the second plurality of fabrics respectively at each of the processing nodes; and
transmitting messages from one or more of the processing nodes as a source node to one or more of the other processing nodes as a destination node in response to transactions requested by one or more I/O services layers of the source node, the messages transmitted over one of the first and second plurality of fabrics in accordance with the current mapping maintained by the source node and which of the first and second virtual fabrics is specified by the transaction requests.

2. The method of claim 1 further comprising changing the current mapping at one or more of the plurality of processing nodes to a different mapping in accordance with a predetermined algorithm.

3. The method of claim 2 wherein the predetermined algorithm is designed to distribute messages substantially evenly over the first and second plurality of fabrics.

4. The method of claim 2 wherein said changing the current mapping is performed on a processing node-by-processing node basis.

5. The method of claim 4 wherein said changing the current mapping is performed for a particular destination node only when doing so will not cause packets comprising a message destined for the particular destination node to be delivered out of order when they are required to be received in order.

6. The method of claim 5 wherein said changing the current mapping is performed for the particular destination node when one of the one or more I/O services layers of the source node switches between the first and second virtual fabrics over which the source node requests messages to be transmitted to the particular destination node.

7. The method of claim 6 wherein the mapping at each processing node is maintained by a network services layer that initiates transactions between one of the plurality of processing nodes as the source node and one or more of the processing nodes as the destination node as requested by the one or more I/O services layers of the source node.

8. The method of claim 7 wherein one of the one or more I/O services layers is a messaging system for initiating interprocessor message transactions between two or more of the plurality of processing nodes that are processor nodes.

9. The method of claim 8 wherein the one or more I/O services layers includes storage interface services and drivers for requesting data transactions between two or more of the plurality of processing nodes that are controller nodes.

10. The method of claim 7 wherein said changing the current mapping for the particular processing node further comprises calling an application program interface (API) to the network services layer of the source node by the requesting I/O services layer of the source node, the API specifying a node ID identifying the particular destination node.

11. The method of claim 8 wherein the first plurality of fabrics the second plurality of fabrics are interprocessor communication (IPC) buses coupling together the processor nodes.

12. The method of claim 9 wherein the first plurality of fabrics and the second plurality of fabrics comprise a system area network (SAN) coupling together the plurality of processing nodes.

13. A computer system having a a first plurality and a second plurality of fabrics coupling a plurality of processing nodes of a computer system, the first plurality of fabrics expanded from a first virtual fabric and the second plurality of fabrics expanded from a second virtual fabric, said computer system comprising:
means for maintaining a current mapping between the first virtual fabric and one of the first plurality of fabrics and between the second virtual fabric and one of the second plurality of fabrics respectively at each of the processing nodes; and
means for transmitting messages from one or more of the processing nodes as a source node to one or more of the processing nodes as a destination node in response to transactions requested by one or more I/O services layers of the source node, the message being transmitted over one of the first and second plurality of fabrics in accordance with the current mapping maintained by the source node and which of the first and second virtual fabrics is specified in the transaction requests.

14. The computer system of claim 13 further comprising means for changing the current mapping at one or more of the plurality of processing nodes to a different mapping in accordance with a predetermined algorithm.

15. The computer system of claim 14 wherein the predetermined algorithm is designed to distribute packets substantially evenly over the first and second plurality of fabrics.

16. The computer system of claim 14 wherein said means for changing the current mapping changes the current mapping on a processing node-by-processing node basis.

17. The computer system of claim 16 wherein said means for changing the current mapping is performed for a particular destination node only when doing so will not cause packets comprising a message destined for the particular destination node to be delivered out of order when they are required to be received in order.

18. The computer system of claim 17 wherein said means for changing the current mapping is performed for the particular destination node when one of the one or more I/O services layers of the source node switches between the first and second virtual fabrics over which the source node requests messages to be transmitted to the particular destination node.

19. The computer system of claim 18 wherein the mapping at each processing node is maintained by a network services layer that initiates transactions between one of the plurality of processing nodes as a source node and one or more of the processing nodes as a destination node as requested by the one or more I/O services layers of the source node.

20. The computer system of claim 19 wherein one of the one or more I/O services layers is a messaging system for initiating interprocessor message transactions over one of the first and second virtual fabrics between two or more of the plurality of processing nodes that are processor nodes.

21. The computer system of claim 20 wherein the one or more I/O services layers includes storage interface services and drivers for requesting data transactions over one of the first and second virtual fabrics between two or more of the plurality of processing nodes that are controller nodes.

22. The computer system of claim 19 wherein said means for changing the current mapping for the destination processing node further comprises calling an API to the network services layer by the requesting I/O services layer of source processing node, the API specifying a node ID identifying the destination processing node.

23. The computer system of claim 20 wherein the first plurality of fabrics and the second plurality of fabrics are IPC buses coupling together the processor nodes.

24. The computer system of claim 21 wherein the first plurality of fabrics and the second plurality of fabrics comprise a system area network (SAN) coupling together the plurality of processing nodes.

25. A method of expanding the number of fabrics coupling a plurality of processing nodes of a computer system from a first virtual fabric and second virtual fabric to a first plurality of fabrics and a second plurality of fabrics, said method comprising:
maintaining a current mapping at each of the processing nodes between the first virtual fabric and one of the first plurality of fabrics and between the second virtual fabric and one of the second plurality of fabrics respectively for each of the other processing nodes;
transmitting packets from one or more of the processing nodes as a source node to one or more of the processing nodes as a destination node in response to transactions requested by one or more I/O services layers of the source node, the messages being transmitted over one of the first ands second plurality of fabrics in accordance with the current mapping maintained by the source node and which of the first and second virtual fabrics is specified by the transaction requests; and
changing the current mapping at one or more of the plurality of processing nodes to a different mapping in accordance with a predetermined algorithm.

26. The method of claim 25 wherein said changing the current mapping is performed for a particular destination node only when doing so will not cause packets comprising messages destined for the particular destination node to be delivered out of order when they are required to be received in order.

27. The method of claim 25 wherein said changing the current mapping is performed for the particular destination node when one of the one or more I/O services layers of the source node switches between the first and second virtual fabrics over which the source node specifies messages to be transmitted to the destination processing node.

28. The method of claim 25 wherein the mapping is maintained at each processing node by a network services layer that initiates transactions between one of the plurality of processing nodes as the source node and one or more of the processing nodes as the destination node as requested by the one or more I/O services layers of the source processing node, the network services layer being hierarchically distinct from the one or more I/O services layers.

29. The method of claim 26 wherein said changing the current mapping for the destination processing node further comprises calling an API to the network services layer of the source node by the requesting I/O services layer of the source node, the API specifying a node ID identifying the destination processing node.

30. A computer system comprising:
a plurality of processing nodes redundantly coupled to one another through a first plurality of fabrics and a second plurality of fabrics;
one or more I/O services layers operable to request transactions between one or more of the plurality of processing node as a source node and one or more of the plurality of processing nodes as destination nodes over a first virtual fabric and second virtual fabric; and
a network services layer, an instantiation of which resides in each one of the processing nodes, operable to maintain a current mapping between the first virtual fabric and one of the first plurality of fabrics and between the second virtual fabric and one of the second plurality of fabrics respectively for each of the processing nodes, the network services layer further operable to initiate transactions requested by the one or more I/O services of the source node to the destination node over the first and second plurality of fabrics in accordance with the current mapping and which of the first and second virtual fabrics is specified in the transaction requests.

31. The computer system of claim 30 wherein the network services layer is operable to change the current mapping for each of the plurality of processing nodes to a different mapping in accordance with a predetermined algorithm.

32. The computer system of claim 31 wherein the predetermined algorithm is designed to distribute messages substantially evenly over the first and second plurality of fabrics between the processing nodes.

33. The computer system of claim 32 wherein said one or more I/O services layers of each processing node includes an application programming interface (API) configured to notify the network services layer of the source node whenever it is safe to change the current mapping for a particular destination node.

34. The computer system of claim 31 wherein one of the one or more I/O services layers is a messaging system operable to initiate interprocessor message transactions between two or more of the plurality of processing nodes that are processor nodes.

35. The computer system of claim 34 wherein the one or more I/O services layers includes storage interface services and drivers operable to request data transactions between two or more of the plurality of processing nodes that are controller nodes.

36. The computer system of claim 34 wherein the first plurality of fabrics and the second plurality of fabrics are IPC buses coupling together the processor nodes.

37. The computer system of claim 35 wherein the first plurality of fabrics and the second plurality of fabrics comprise a system area network (SAN) coupling together the plurality of processing nodes.
